(19) United States
(12) Patent Application Publication
(10) Pub. No.: US 2026/0063978 A1
(43) Pub. Date: Mar. 5, 2026

(54) PROJECTION DEVICE

(71) Applicant: Coretronic Corporation, Hsin-Chu (TW)

(72) Inventors: Chun-Ting Lin, Hsin-Chu (TW); Wen-Yen Chung, Hsin-Chu (TW)

(73) Assignee: Coretronic Corporation, Hsin-Chu (TW)

(21) Appl. No.: 19/312,306

(22) Filed: Aug. 28, 2025

(30) Foreign Application Priority Data
Aug. 30, 2024 (CN) 202411208896.2

(51) Int. Cl. G03B 21/16

(52) U.S. Cl. CPC G03B 21/16

(57) ABSTRACT

A projection device including a housing, a projection lens, a first light source module, a first heat dissipation module, and a first fan. A lower cover, a first side cover, and a second side cover of the housing respectively include a first air inlet, a second air inlet, and an air outlet. The projection lens has a disposition direction to divide an accommodating space in the housing into first and second regions. The first heat dissipation module includes a base, at least one first heat pipe, and heat dissipation fins. The first heat pipe is perpendicular to the base, and the heat dissipation fins are parallel to the base. Air outlet and inlet surfaces of the first fan respectively faces the upper and lower covers. An angle between a normal extension direction of the air inlet surface and the first air inlet falls between 30 degrees to 150 degrees.

### CROSS-REFERENCE TO RELATED APPLICATION

This application claims the priority benefit of China application serial no. 202411208896.2, filed on Aug. 30, 2024. The entirety of the above-mentioned patent application is hereby incorporated by reference herein and made a part of this specification.

### BACKGROUND

### Technical Field

The disclosure relates to an optical device, and in particular to a projection device.

### Description of Related Art

In general, in the housing of an ultra-short-throw projection device, there is a light dispersion angle (also referred to as a cone angle) at the upper cover. This light dispersion angle is located along the transmission path of the image light beam from the projection lens. Due to the presence of this light dispersion angle, a fan cannot be placed downstream of the heat dissipation fins, i.e., the heat dissipation fins are located between the air inlet and the fan, and the fan must be moved outside of this light dispersion angle to meet heat dissipation needs. However, this configuration restricts the size and placement of the fan, and moving the fan outside causes greater noise, which in turn affects the heat dissipation performance and noise level of the projection device. Furthermore, the presence of the light dispersion angle limits the length of the heat dissipation fins, which may lead to insufficient heat dissipation surface area and affect the heat dissipation efficiency of the projection device. Additionally, when the brightness and heat of the projection device increase, the only options are to increase the size of the heat dissipation fins or raise the fan's rotation speed, which would result in either a bulkier device or more noise.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection device designed to achieve better heat dissipation performance.

Other objectives and advantages of this disclosure can be further understood from the technical features revealed in this specification.

To achieve part or all of these objectives, an embodiment of the disclosure proposes a projection device that includes a housing, a projection lens, a first light source module, a first heat dissipation module, and a first fan. The housing includes a front cover and rear cover opposite to each other, a first side cover and second side cover opposite to each other, as well as an upper cover and lower cover. The first side cover and second side cover are connected to the front cover and rear cover, while the upper cover and lower cover connect the front, rear, first side, and second side covers to form an accommodating space. The lower cover has a first air inlet, the first side cover has a second air inlet, and the second side cover has an air outlet. The projection lens is disposed inside the housing and has a disposition direction that divides the accommodating space into a first region and a second region. The first air inlet and second air inlet are located in the first region, while the air outlet is located in the second region. The first light source module, first heat dissipation module, and first fan are all located in the first region. The first light source module is connected to the first heat dissipation module, which is located between the first air inlet and the first fan. The first heat dissipation module includes a base, at least one first heat pipe, and multiple heat dissipation fins. The base is connected to the first light source module. The first heat pipe is perpendicular to the base, while the heat dissipation fins are parallel to the base. The first fan has an air outlet surface facing the upper cover and an air inlet surface facing the lower cover, with the angle between the normal direction of the air inlet surface and the first air inlet falling between 30 degrees and 150 degrees.

Based on the above, this embodiment of the disclosure offers at least one of the following advantages or effects. In the design of the projection device, the lower cover of the housing has a first air inlet, and the first light source module is connected to the first heat dissipation module, which is located between the first air inlet and the first fan. This means that the first fan is disposed downstream of the airflow from the first heat dissipation module, between the first heat dissipation module and the upper cover, rather than near the side cover. This improves the heat dissipation efficiency of the first heat dissipation module for the first light source module, and also reduces noise as the sound from the first fan is less likely to escape through the side cover. Moreover, the first heat pipe in the first heat dissipation module is perpendicular to the base, and the heat dissipation fins are parallel to the base. Hence, comparing to the bent heat pipes connected to the base in the current technology, the first heat dissipation module in the embodiment of the disclosure does not need to take into account the space occupied by bent heat pipes, allowing for increased surface area of the heat dissipation fins and better space utilization within the accommodating space. Additionally, the first fan is not disposed upright parallel to the side cover but rather horizontally or at an angle within the accommodating space, with the air outlet surface facing the upper cover and the air inlet surface facing the lower cover at an angle between 30 degrees and 150 degrees relative to the first air inlet. In summary, the projection device described in the disclosure offers improved heat dissipation, reduced noise, and enhanced space efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a top view schematic diagram of a projection device according to an embodiment of the disclosure.

FIG. 1B is a front view schematic diagram of FIG. 1A.

FIG. 1C is a side view schematic diagram of FIG. 1A.

FIG. 1D is a schematic diagram of the first heat dissipation module in the projection device of FIG. 1A.

FIG. 2 is a front view schematic diagram of a projection device according to another embodiment of the disclosure.

FIG. 3 is a schematic diagram of a first heat dissipation module according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

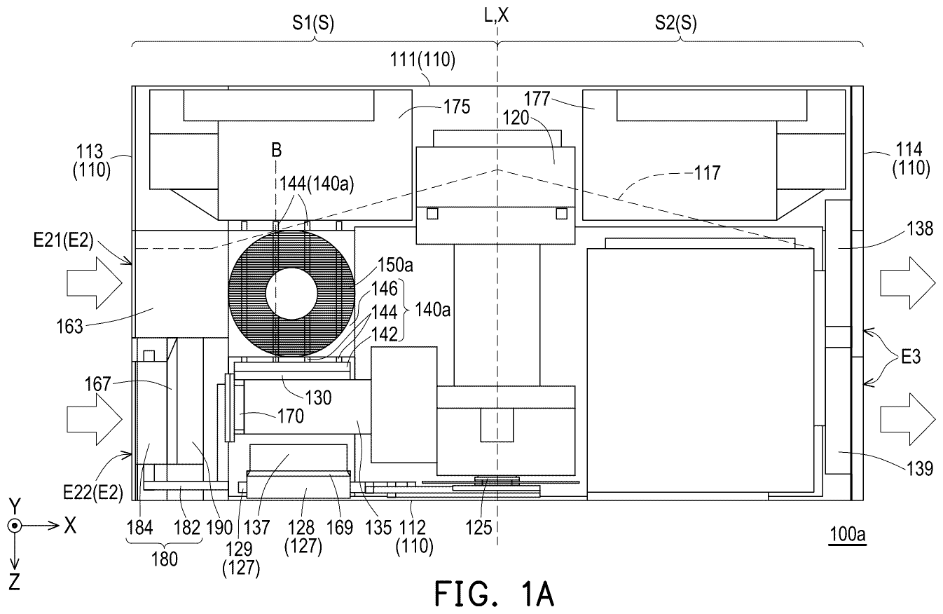

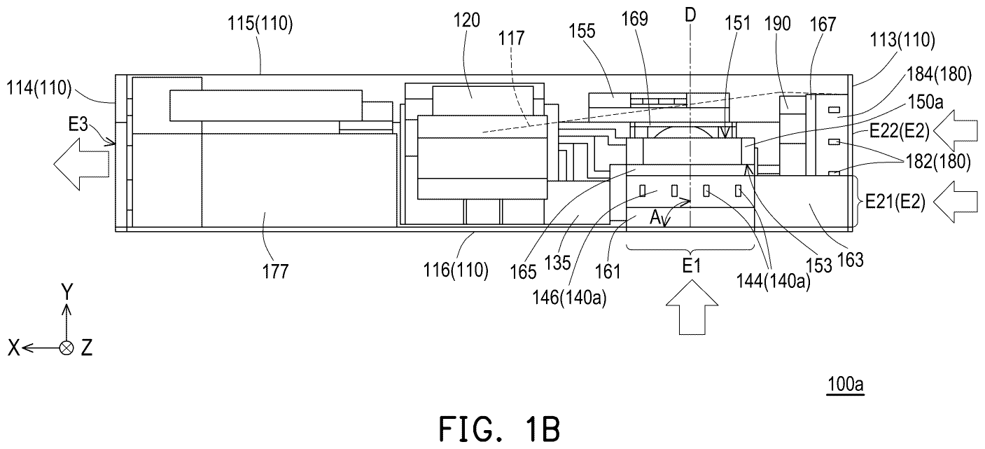

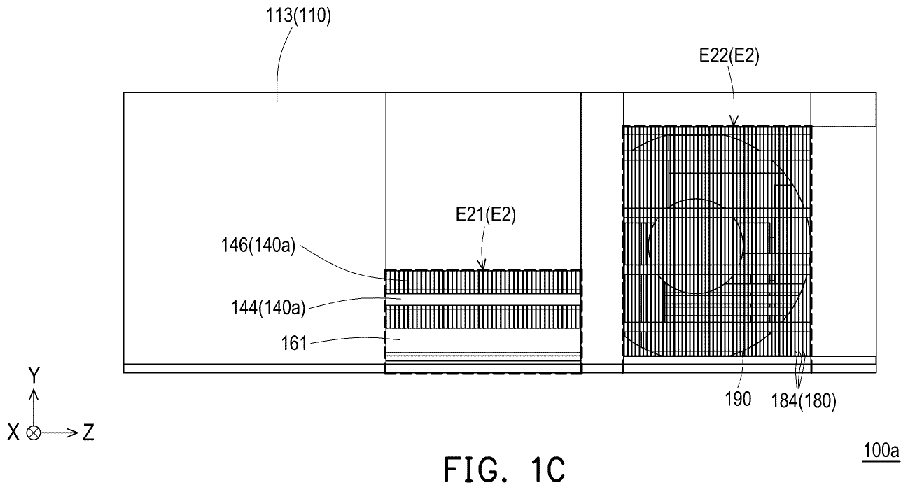

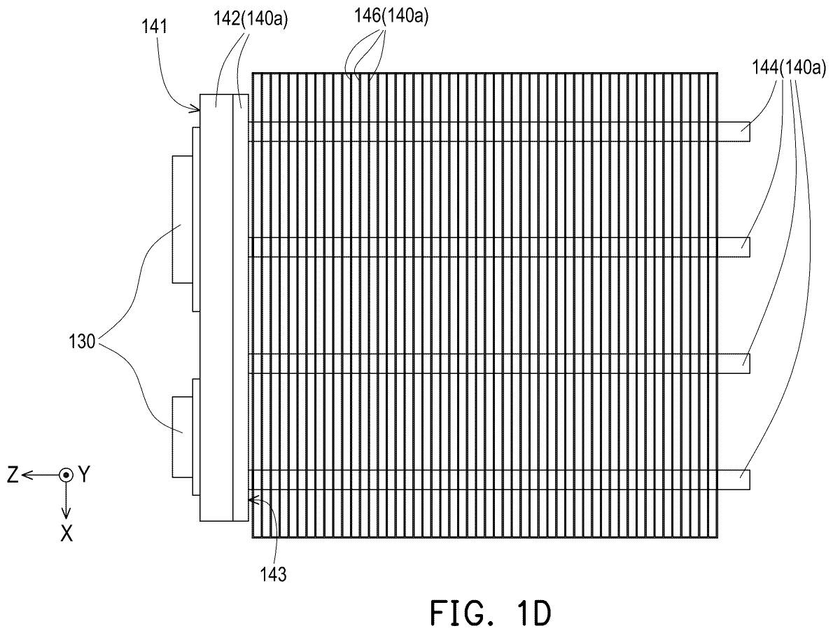

FIG. 1A is a top view schematic diagram of a projection device according to an embodiment of the disclosure. FIG. 1B is a front view schematic diagram of FIG. 1A. FIG. 1C is a side view schematic diagram of FIG. 1A. FIG. 1D is a schematic diagram of the first heat dissipation module in the projection device of FIG. 1A. It should be noted that, for the sake of clarity, some components such as a speaker 175 are omitted from FIG. 1B.

Referring to FIGS. 1A, 1B, 1C, and 1D, in this embodiment, the projection device 100a includes a housing 110, a projection lens 120, a first light source module 130, a first heat dissipation module 140a, and a first fan 150a. The housing 110 includes a front cover 111 and a rear cover 112 that are opposite to each other, a first side cover 113 and a second side cover 114 that are opposite to each other, and an upper cover 115 and a lower cover 116 that are opposite to each other. The first side cover 113 and the second side cover 114 are connected to the front cover 111 and the rear cover 112, respectively. The upper cover 115 and the lower cover 116 connect the front cover 111, rear cover 112, first side cover 113, and second side cover 114 to form an accommodating space S. The lower cover 116 has a first air inlet E1, the first side cover 113 has a second air inlet E2, and the second side cover 114 has an air outlet E3. The projection lens 120 is disposed inside the housing 110. The projection lens 120 has a disposition direction L that divides the accommodating space S into a first region S1 and a second region S2. The first air inlet E1 and the second air inlet E2 are located in the first region S1, while the air outlet E3 is located in the second region S2. The first light source module 130, first heat dissipation module 140a, and first fan 150a are all located in the first region S1. The first light source module 130 is connected to the first heat dissipation module 140a, and the first heat dissipation module 140a is located between the first air inlet E1 and the first fan 150a. The first heat dissipation module 140a includes a base 142, at least one first heat pipe (four first heat pipes 144 are schematically shown), and multiple heat dissipation fins 146. The base 142 is connected to the first light source module 130. The first heat pipes 144 are perpendicular to the base 142, while the heat dissipation fins 146 are parallel to the base 142. The first fan 150a has an air outlet surface 151 and an air inlet surface 153. The air outlet surface 151 faces the upper cover 115, while the air inlet surface 153 faces the lower cover 116. An angle A between a normal extension direction D of the air inlet surface 153 and the first air inlet E1 is between 30 degrees and 150 degrees.

Specifically, in this embodiment, the housing 110 can be made from materials such as metal (e.g., aluminum), plastic, or resin (e.g., white polycarbonate, white polysiloxane), but is not limited thereto. The upper cover 115 of the housing 110 has a light-emitting portion 117, which is located on the transmission path of the image light beam from the projection lens 120. Here, the light-emitting portion 117 may be, for example, a light dispersion angle (also referred to as a cone angle), the purpose of which being to prevent the image light beam from the projection lens 120 from being blocked. Referring again to FIGS. 1B and 1C, in this embodiment, the airflow direction of the first air inlet E1 differs from that of the second air inlet E2, where the airflow direction of the first air inlet E1 can be perpendicular to the airflow direction of the second air inlet E2. Preferably, the ratio of the area of the second air inlet E2 to the area of the first air inlet E1 may be, for example, between 0.5 and 1. In other words, the area of the second air inlet E2 can be smaller than or equal to the area of the first air inlet E1. A smaller second air inlet E2 can reduce the noise generated by the fan, as the noise would be less likely to escape through the second air inlet E2, thereby reducing noise and improving the user experience of the projection device 100a. The projection device 100a in this embodiment enhances heat dissipation by drawing air in through the first air inlet E1 in the lower cover 116 and the second air inlet E2 in the first side cover 113, achieving better cooling performance.

In this embodiment, the number of second air inlets E2 can be one or more. For example, there are two second air inlets E2, specifically designated as second air inlets E21 and E22. The second air inlet E21 corresponds to the first heat dissipation module 140a and is used to dissipate heat from the first light source module 130. The second air inlet E22 corresponds to another heat dissipation module (e.g., a second heat dissipation module 180) and is used to cool other heat-generating elements (e.g., a second light source module 170). In this embodiment, the area of the second air inlet E21 is smaller than or equal to the area of the first air inlet E1, and the ratio of the area of the second air inlet E21 to the area of the first air inlet E1 may be, for example, between 0.5 and 1.

Furthermore, in this embodiment, the projection lens 120 is specifically an ultra-short-throw projection lens, where the throw ratio (TR) of the projection lens 120 is, for example, less than 0.3. The throw ratio is defined as the projection distance divided by the projection screen width. As shown in FIG. 1A, the projection lens 120 is located in the middle between the first side cover 113 and the second side cover 114 of the housing 110. In other words, an optical axis X of the projection lens 120 is, for example, located in the middle of the housing 110, meaning the size of the first region S1 and the second region S2 can be approximately the same.

Referring again to FIG. 1A, in this embodiment, the projection device 100a further includes a light valve 125 and a heat dissipation module 127. The light valve 125 is disposed inside the housing 110 and located between the rear cover 112 and the projection lens 120. The heat dissipation module 127 is disposed inside the housing 110, located in the first region S1, and connected to the light valve 125 to dissipate heat from the light valve 125. In an embodiment, the light valve 125 is, for example, a digital micromirror device (DMD), composed of thousands of microscopic mirrors that can automatically flip and adjust to the corresponding reflection angles to reflect the image light beam to the projection lens 120. In another embodiment, the light valve 125 may also be a transmissive spatial light modulator, such as a transparent liquid crystal panel. The type and form of the light valve 125 are not limited by the disclosure.

The first light source module 130 in this embodiment may include at least one light-emitting element used to provide an illumination light beam. For example, the first light source module 130 may include multiple laser diodes, light-emitting diodes, or a combination of the two, arranged in an array, or it could be another suitable solid-state illumination source. In an embodiment, these light-emitting elements may include a red light-emitting unit, a blue light-emitting unit, a green light-emitting unit, or a combination thereof, capable of emitting red, blue, green light, or a combination of these to form the illumination light beam. The projection lens 120 may include a combination of one or more optical lenses with refractive power, such as various combinations of non-planar lenses, including biconcave, biconvex, concave-convex, convex-concave, plano-convex, or plano-concave lenses. In an embodiment, the projection lens 120 may include flat optical lenses and project the image light beam from the light valve 125 either by reflection or transmission from the projection device 100a.

In this embodiment, the projection device 100a further includes an optical path guiding module 135, which is installed inside the housing 110. The first light source module 130 provides the illumination light beam, and the optical path guiding module 135 is disposed on the transmission path of the illumination light beam to direct it toward the light valve 125. In an embodiment, the optical path guiding module 135 may include lenses, mirrors, or a combination of both, which are used to reflect, refract, or converge the light beam. For example, the lens could be a convex lens, concave lens, or a combination of concave and convex lenses with various refractive surfaces, but is not limited to these options.

Referring again to FIGS. 1A and 1B, in this embodiment, the first air inlet E1, located on the lower cover 116, is aligned with the first heat dissipation module 140a to enhance heat dissipation efficiency. In an embodiment, the top projection of the first heat dissipation module 140a on the lower cover 116 overlaps at least partially with the first air inlet E1. The area of the first air inlet E1 may be equal to the area of the air inlet surface 153 of the first fan 150a. On a reference plane parallel to the front cover 111, the first fan 150a is located between the light-emitting portion 117 and the first heat dissipation module 140a. The first light source module 130 is connected to the first heat dissipation module 140a, and the first heat dissipation module 140a is located between the first air inlet E1 and the first fan 150a. This means that the first fan 150a is disposed downstream of the airflow from the first heat dissipation module 140a and is located between the first heat dissipation module 140a and the upper cover 115, rather than near the first side cover 113. This setup improves the heat dissipation efficiency of the first heat dissipation module 140a for the first light source module 130, and the noise generated by the first fan 150a is less likely to escape through the first side cover 113, effectively reducing noise. Compared to conventional designs that require two fans for cooling the light source module, this embodiment of the projection device 100a uses only the first fan 150a to cool the light source module 130, reducing the number of fans needed and lowering the power consumption of the projection device 100a. Additionally, as shown in FIG. 1B, the angle A between the normal direction D of the air inlet surface 153 of the first fan 150a and the first air inlet E1 falls between 30 degrees to 150 degrees (e.g., 90 degrees), meaning the first fan 150a lies flat in the first region S1, parallel to the upper cover 115 and the lower cover 116. In this embodiment, the first fan 150a may be, for example, an axial flow fan or a blower.

Furthermore, in this embodiment, the first heat dissipation module 140a is specifically a three-dimensional vapor chamber (3-D vapor chamber, 3DVC). Referring to FIGS. 1A and 1D, the base 142 of the first heat dissipation module 140a is flat, with a first surface 141 and a second surface 143 opposite each other. The first light source module 130 is connected to the first surface 141 of the base 142, while the first heat pipe 144 is vertically attached directly to the second surface 143 of the base 142, and the heat dissipation fins 146 are parallel to the base 142. An extension direction B of the first heat pipe 144 is parallel to the optical axis X of the projection lens 120. This means that the heat dissipation fins 146 are aligned parallel to the front cover 111 and the rear cover 112 (i.e., arranged horizontally), and the first heat pipe 144 is parallel to the optical axis X. This design allows the heat dissipation fins 146 to have the largest possible surface area facing the airflow. In other words, the design of the first heat dissipation module 140a in this embodiment avoids the need for extra space typically required by the bent heat pipes in conventional designs (i.e., where the flattened, bent sections of the heat pipes take up additional space). As a result, the heat dissipation fins 146 have an increased surface area for cooling (approximately 32% more compared to conventional heat dissipation modules), which enables better heat dissipation efficiency within the limited space.

In an embodiment, the base 142 and the first heat pipe 144 of the first heat dissipation module 140a can be integrally formed, which effectively reduces the thermal resistance caused by welding. In another embodiment, the first heat dissipation module 140a may be made from a metal material with a thermal conductivity greater than 90 W/(m·K), such as aluminum, copper, or stainless steel. In yet another embodiment, the base 142 of the first heat dissipation module 140a could be a two-dimensional vapor chamber (2-D vapor chamber), but this is not limiting.

Moreover, to further enhance heat dissipation efficiency, the projection device 100a in this embodiment may also include a first air guide plate 161, disposed between the first air inlet E1 and the first heat dissipation module 140a. This directs airflow from the first air inlet E1, through the first heat dissipation module 140a, and toward the first fan 150a, and the air guide plate 161 helps prevent air recirculation. The projection device 100a may also include a second air guide plate 163, disposed between the second air inlet E2 (E21) and the first heat dissipation module 140a, connecting the second air inlet E21 to the side wall of the frame of the first fan 150a, to guide cold air to the first heat dissipation module 140a. Additionally, the projection device 100a may include a third air guide plate 165, disposed between the first heat dissipation module 140a and the first fan 150a, ensuring that cold air directly cools both opposing air inlet surfaces of the first heat dissipation module 140a (i.e., parallel to the X direction). In an embodiment, simulated experiments have shown that the design of the lower cover 116 with the first air inlet E1 and the first side cover 113 with the second air inlet E2 effectively lowers the inlet air temperature and increases airflow. In another embodiment, the air guide plates 161, 163, and 165 may also have sound-absorbing foam attached to them to absorb the sound of the airflow, effectively reducing the noise generated by the fan during operation.

Referring again to FIGS. 1A and 1B, in this embodiment, the projection device 100a also includes a second light source module 170, a second heat dissipation module 180, and a second fan 190, all located within the first region S1. The second heat dissipation module 180 and the second fan 190 are used to dissipate heat from the second light source module 170. The second light source module 170 may include at least one light-emitting element to provide the illumination light beam. For example, the second light source module 170 may include multiple laser diodes, light-emitting diodes, or a combination of the two, arranged in an array, or it could be another suitable solid-state illumination source. In an embodiment, these light-emitting elements may include red, blue, or green light-emitting units, or a combination of these, to emit red, blue, and green light beams, forming the illumination light beam.

Moreover, in this embodiment, the second heat dissipation module 180 includes at least one second heat pipe (multiple second heat pipes 182 are schematically shown) and a heat dissipation fin set 184 connected to the second heat pipes 182. The second light source module 170 is connected to the second heat pipes 182, and the second fan 190 is located between the heat dissipation fin set 184 and the second light source module 170. In an embodiment, the extension direction of the second heat pipes 182 (Z direction) may be the same as the extension direction of the first heat pipes 144 (Z direction). The arrangement direction of the multiple second heat pipes 182 (Y direction) may be perpendicular to the arrangement direction of the multiple first heat pipes 144 (X direction). The arrangement direction of the fins in the heat dissipation fin set 184 of the second heat dissipation module 180 (Y direction) may be perpendicular to the arrangement direction of the multiple heat dissipation fins 146 of the first heat dissipation module 140a (X direction). The orientation of the second fan 190 (parallel to the YZ plane) may be perpendicular to the orientation of the first fan 150a (parallel to the XZ plane). To enhance cooling efficiency, the projection device 100a may also include a fourth air guide plate 167, disposed between the second fan 190 and the second heat dissipation module 180. Cold air enters through the second air inlet E2 (E22) and first cools the second light source module 170. The hot air is then drawn out by system fans 138 and 139 located near the second side cover 114 and is expelled through the air outlet E3. The airflow path from the second heat dissipation module 180 to the second fan 190 is equipped with the air guide plate 167, ensuring the airflow passes directly through the second heat dissipation module 180 for heat dissipation, preventing the airflow from bypassing. The second fan 190 and the system fans 138 and 139 may be, for example, axial flow fans or blowers.

Furthermore, in this embodiment, the projection device 100a also includes a system fan 137, which is located inside the housing 110 between the optical path guiding module 135 and a heat dissipation fin set 128 of the heat dissipation module 127. The heat dissipation fin set 128 is connected to a heat pipe 129, which can be connected to the base of the light valve 125 to dissipate heat from the light valve 125. In an embodiment, the system fan 137 may be, for example, an axial flow fan or a blower. To further enhance cooling performance, the projection device 100a may also include a fifth air guide plate 169, disposed between the heat dissipation fin set 128 of the heat dissipation module 127 and the system fan 137. This air guide plate 169 directs cold air entering the housing 110 through an air inlet (not shown in the figures) on the rear cover 112 to flow directly toward the heat dissipation fin set 128, without passing over other heat-generating elements. The system fan 137 then exhausts the air, achieving improved cooling performance for the heat dissipation fin set 128.

Additionally, the projection device 100a in this embodiment includes a driver circuit board 155, located between the first heat dissipation module 140a and the upper cover 115, which optimizes the space utilization of the projection device 100a. In an embodiment, the driver circuit board 155 may be, for example, a driver board for the light-emitting elements or a printed circuit board (PCB), used to drive the first light source module 130 and the second light source module 170. Furthermore, the projection device 100a may also include two speakers 175 and 177, which are disposed inside the housing 110 and respectively located in the first region S1 and the second region S2. The two speakers 175 and 177 are disposed near the front cover 111, and the projection lens 120 is located between the two speakers 175 and 177.

In summary, this embodiment reshapes the internal airflow by leveraging the space below the light-emitting portion 117 of the upper cover 115. As a result, the projection device 100a becomes more compact and operates with significantly less fan noise. By adopting a three-dimensional vapor chamber for heat dissipation module 140a, its volume is reduced by about 17% compared to conventional designs, which improves internal space utilization and lowers overall device weight. Additionally, since the first fan 150a is disposed away from the first side cover 113 and inside the accommodating space S between the first heat dissipation module 140a and the upper cover 115, the noise level of the projection device 100a is further reduced.

Other embodiments are provided for description as follows. It should be noted that the subsequent embodiments will reuse the reference numerals and some content from the previous embodiments, where the same numerals represent the same or similar elements, and the explanations of identical technical content are omitted. For the omitted parts, refer to the previous embodiments, and the following embodiments will not repeat the explanations.

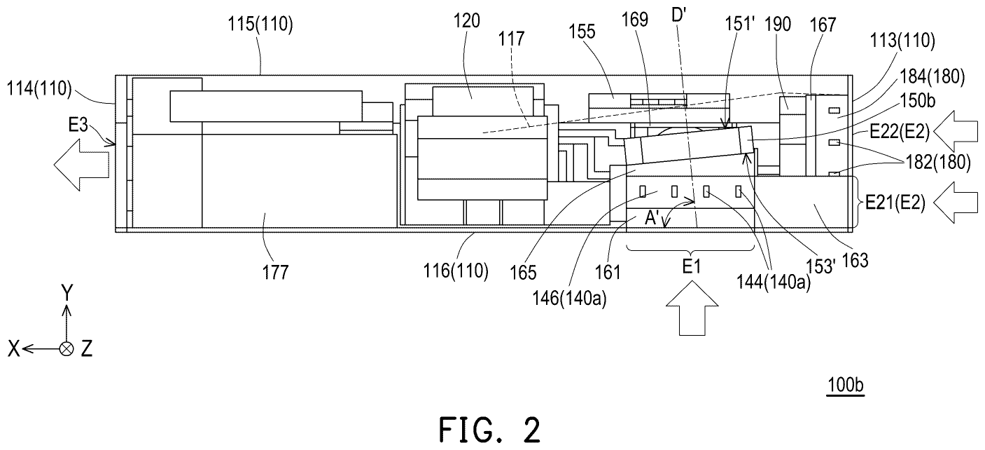

FIG. 2 is a front view schematic diagram of a projection device according to another embodiment of the disclosure. Referring to both FIG. 1B and FIG. 2, this embodiment's projection device 100b is similar to the projection device 100a described earlier, with the main difference being: in this embodiment, a first fan 150b has an air outlet surface 151′ and an air inlet surface 153′, where the air outlet surface 151′ faces the upper cover 115, and the air inlet surface 153′ faces the lower cover 116. The angle A′ between the normal extension direction D′ of the air inlet surface 153′ and the first air inlet E1 falls between 30 degrees and 150 degrees, such as 30 degrees to 89 degrees. In other words, the first fan 150b is placed at an inclined angle relative to the upper cover 115 and the lower cover 116, lying diagonally rather than horizontally parallel to the upper and lower covers. The first fan 150b is positioned, for example, inclined toward the second side cover 114, so that the air outlet surface 151′ of the first fan 150b faces the air outlet E3 on the second side cover 114, achieving better heat dissipation.

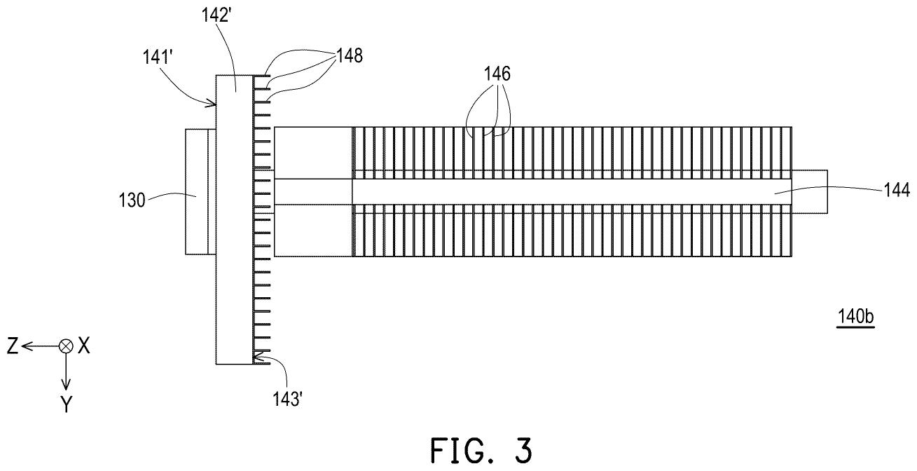

FIG. 3 is a schematic diagram of a first heat dissipation module according to another embodiment of the disclosure. Referring to both FIG. 1D and FIG. 3, a first heat dissipation module 140b in this embodiment is similar to the first heat dissipation module 140a described earlier, with the main difference being: in this embodiment, a base 142′ of the first heat dissipation module 140b has a first surface 141′ and a second surface 143′, which are opposite each other. The first surface 141′ is connected to the first light source module 130. The first heat dissipation module 140b also includes multiple auxiliary fins 148, which are disposed on the second surface 143′, and these auxiliary fins 148 are perpendicular to the base 142′. In other words, in this embodiment, the first heat dissipation module 140b not only has heat dissipation fins 146 that are parallel to the base 142′, but also has auxiliary fins 148 that are perpendicular to the base 142′, thereby increasing the overall heat dissipation area.

In summary, the embodiments of the disclosure offer at least one of the following advantages or effects. In the design of the projection device, the lower cover of the housing has a first air inlet, where the first light source module is connected to the first heat dissipation module, and the first heat dissipation module is located between the first air inlet and the first fan. This means that the first fan is positioned downstream of the airflow from the first heat dissipation module and is located between the first heat dissipation module and the upper cover, rather than near the side cover. This setup enhances the heat dissipation efficiency of the first heat dissipation module for the first light source module, and the noise generated by the first fan is less likely to be transmitted through the side cover, effectively reducing noise. Furthermore, the first heat pipes of the first heat dissipation module are vertical to the base, and the heat dissipation fins are parallel to the base. Compared to conventional designs where bent heat pipes occupy additional space, the first heat dissipation module in this embodiment does not require extra space for bent heat pipes, which effectively increases the heat dissipation area of the fins and improves the space utilization within the accommodating space. Additionally, the first fan's air outlet surface faces the upper cover, and the air inlet surface faces the lower cover, with the angle between the normal direction of the air inlet surface and the first air inlet falling between 30 degrees and 150 degrees. This means that the first fan is not disposed upright, parallel to the side cover, but is lying flat or inclined within the accommodating space. In short, the projection device of the disclosure achieves better heat dissipation, effectively reduces noise, and enhances space utilization within the device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection device, comprising: a housing, a projection lens, a first light source module, a first heat dissipation module, and a first fan, wherein:
the housing comprises a front cover and a rear cover opposite to each other, a first side cover and a second side cover opposite to each other, and an upper cover and a lower cover opposite to each other, the first side cover and the second side cover being respectively connected to the front cover and the rear cover, the upper cover and the lower cover being connected to the front cover, the rear cover, the first side cover, and the second side cover respectively to form an accommodating space, wherein the lower cover has a first air inlet, the first side cover has a second air inlet, and the second side cover has an air outlet;
the projection lens is disposed in the housing, the projection lens having a disposition direction to divide the accommodating space into a first region and a second region, wherein the first air inlet and the second air inlet are located in the first region, and the air outlet is located in the second region;
the first light source module, the first heat dissipation module, and the first fan are located in the first region, wherein the first light source module is connected to the first heat dissipation module, and the first heat dissipation module is located between the first air inlet and the first fan;
the first heat dissipation module comprises a base, at least one first heat pipe, and a plurality of heat dissipation fins, the base being connected to the first light source module, the at least one first heat pipe being perpendicular to the base, and the plurality of heat dissipation fins being parallel to the base; and
the first fan has an air outlet surface and an air inlet surface, the air outlet surface facing the upper cover, the air inlet surface facing the lower cover, wherein an angle between a normal extension direction of the air inlet surface and the first air inlet falls between 30 degrees to 150 degrees.

2. The projection device according to claim 1, wherein a ratio of an area of the second air inlet to an area of the first air inlet falls between 0.5 and 1.

3. The projection device according to claim 1, further comprising:
an air guide plate, disposed between the first air inlet and the first heat dissipation module.

4. The projection device according to claim 1, further comprising:
an air guide plate, disposed between the second air inlet and the first heat dissipation module.

5. The projection device according to claim 1, further comprising:
an air guide plate, disposed between the first heat dissipation module and the first fan.

6. The projection device according to claim 1, further comprising:
a second light source module, a second heat dissipation module, and a second fan, located in the first region, wherein the second heat dissipation module comprises at least one second heat pipe and a heat dissipation fin set connected to the at least one second heat pipe, the second light source module is connected to the at least one second heat pipe, and the second fan is located between the heat dissipation fin set and the second light source module.

7. The projection device according to claim 6, further comprising:
an air guide plate, disposed between the second fan and the second heat dissipation module.

8. The projection device according to claim 1, further comprising:
a light valve, disposed in the housing and located between the rear cover and the projection lens; and
a heat dissipation module, disposed in the housing and located in the first region, wherein the heat dissipation module is connected to the light valve.

9. The projection device according to claim 8, further comprising:
an optical path guiding module, disposed in the housing, wherein the first light source module is used to provide an illumination light beam, and the optical path guiding module is disposed on a transmission path of the illumination light beam and used to transmit the illumination light beam to the light valve.

10. The projection device according to claim 9, further comprising:
a system fan, disposed in the housing and located between the optical path guiding module and the heat dissipation fin set of the heat dissipation module.

11. The projection device according to claim 10, further comprising:
an air guide plate, disposed between the heat dissipation fin set of the heat dissipation module and the system fan.

12. The projection device according to claim 1, wherein an extension direction of the at least one first heat pipe of the first heat dissipation module is parallel to an optical axis of the projection lens.

13. The projection device according to claim 1, wherein the base of the first heat dissipation module and the at least one first heat pipe are integrally formed.

14. The projection device according to claim 1, wherein the base of the first heat dissipation module has a first surface and a second surface opposite to each other, the first surface being connected to the first light source module, wherein the first heat dissipation module further comprises a plurality of auxiliary fins disposed on the second surface.

15. The projection device according to claim 14, wherein the plurality of auxiliary fins are perpendicular to the base.

16. The projection device according to claim 1, further comprising:
a drive circuit board, disposed between the first heat dissipation module and the upper cover.

17. The projection device according to claim 1, further comprising:
two speakers, disposed in the housing and respectively located in the first region and the second region, wherein the two speakers are disposed adjacent to the front cover, and the projection lens is located between the two speakers.

18. The projection device according to claim 1, wherein the projection lens is an ultra-short-throw projection lens.

19. The projection device according to claim 1, wherein the upper cover has a light-emitting portion, the light-emitting portion being located on a transmission path of an image light beam from the projection lens and on a reference plane parallel to the lower cover, wherein the first fan is located between the light-emitting portion and the first heat dissipation module.

20. The projection device according to claim 1, wherein the projection lens is located in a middle of the first side cover and the second side cover of the housing.
